(19) United States
(12) Patent Application Publication
(10) Pub. No.: US 2016/0037090 A1
(43) Pub. Date: Feb. 4, 2016

(54) FINDER SYSTEM AND OPTICAL APPARATUS USING THE SAME

(71) Applicant: CANON KABUSHIKI KAISHA, Tokyo (JP)

(72) Inventor: Seiji Nakahara, Sakura-shi (JP)

(21) Appl. No.: 14/816,556

(22) Filed: Aug. 3, 2015

(30) Foreign Application Priority Data
Aug. 4, 2014 (JP) 2014-158591

(51) Int. Cl. H04N 5/335; G03B 13/02

(52) U.S. Cl. CPC H04N 5/335; G03B 13/02

(57) ABSTRACT

Provided is a finder system, including: an observation optical system configured to convert a subject image formed on a predetermined surface into an erect image via an erect image forming member, and cause the erect image to be transmitted through a first optical surface that is inclined with respect to an optical axis, thereby observing the erect image via an eyepiece lens; and a display optical system configured to cause an image indicating display information of a display member to be reflected on the first optical surface, thereby observing the image via the eyepiece lens in the same field of view as the subject image. The display optical system includes an optical member including at least two reflection surfaces and a lens unit having a positive refractive power, along an optical path between the display member and the eyepiece lens in the stated order.

### BACKGROUND OF THE INVENTION

1. Field of the Invention

The present invention relates to a finder system and an optical apparatus using the same, which are particularly suitable for a photographic camera, a video camera, and the like that enable a user to observe a subject image formed on a reticle and an image formed on a display element via a common eyepiece unit.

2. Description of the Related Art

Hitherto, there has been proposed a camera capable of displaying an image of a display element on an optical finder in a superimposed manner or in a switching manner via a common eyepiece unit. In Japanese Patent No. 4154022, there is disclosed a finder in which a half mirror or a dichroic mirror is evaporated on an optical surface between a pentaprism and an eyepiece optical system so that a user is enabled to observe a range-finding frame that is superimposed on a subject image formed on a reticle. Further, in Japanese Patent Application Laid-Open No. 2007-264029, there is disclosed a finder in which an optical path combining member is used so that a user is enabled to observe a display of a display element that is superimposed from a subject-side surface of a pentaprism.

The finder disclosed in Japanese Patent No. 4154022 assumes that a display system displays a range-finding frame with an angle of field that is about half the field of view of the finder. When the angle of field of the display system is increased to approximately 0.8 times as large as the field of view of the finder, the display system is upsized by 10 mm or more in a height direction.

In the finder disclosed in Japanese Patent Application Laid-Open No. 2007-264029, a panel is far from an eyepiece frame, and hence the image to be displayed on the display element is small. Further, the camera is upsized in a subject direction, and hence it is difficult to mount a large-aperture photographing lens to the camera.

### SUMMARY OF THE INVENTION

In order to achieve the above-mentioned object, according to one embodiment of the present invention, there is provided a finder system, including: an observation optical system configured to convert a subject image formed on a predetermined surface into an erect image via an erect image forming member, and cause the erect image to be transmitted through a first optical surface that is inclined with respect to an optical axis, thereby observing the erect image via an eyepiece lens; and a display optical system configured to cause an image indicating display information of a display member to be reflected on the first optical surface, thereby observing the image via the eyepiece lens in the same field of view as the subject image. The display optical system includes, between the display member and the eyepiece lens: an optical member including at least two reflection surfaces; and a lens unit having a positive refractive power, the optical member and the lens unit being arranged along an optical path from the display member side to the eyepiece lens side in the stated order.

Further features of the present invention will become apparent from the following description of exemplary embodiments with reference to the attached drawings.

### BRIEF DESCRIPTION OF THE DRAWINGS

FIG. 1 is a cross-sectional view for illustrating a configuration of a finder optical system according to Numerical Example 1 of the present invention.

FIG. 2 is a cross-sectional view parallel to an optical axis of a display optical system according to Numerical Example 1 of the present invention.

FIG. 3A is a display example of a finder according to Example of the present invention.

FIG. 3B is another display example of the finder according to Example of the present invention.

FIG. 4 is a cross-sectional view for illustrating a configuration of the finder optical system during mirror-up according to Numerical Example 1 of the present invention.

FIG. 5A is an exploded view along an optical axis of an observation optical system according to Numerical Example 1 of the present invention.

FIG. 5B is an exploded view along an optical axis of the display optical system according to Numerical Example 1 of the present invention.

FIG. 6 is a cross-sectional view for illustrating a configuration of a finder optical system according to Numerical Example 2 of the present invention.

FIG. 7 is a cross-sectional view parallel to an optical axis of a display optical system according to Numerical Example 2 of the present invention.

FIG. 8 is a cross-sectional view for illustrating a configuration of the finder optical system during mirror-up according to Numerical Example 2 of the present invention.

FIG. 9A is an exploded view along an optical axis of an observation optical system according to Numerical Example 2 of the present invention.

FIG. 9B is an exploded view along an optical axis of the display optical system according to Numerical Example 2 of the present invention.

FIG. 10 is a cross-sectional view for illustrating a configuration of a finder optical system according to Numerical Example 3 of the present invention.

FIG. 11 is a cross-sectional view parallel to an optical axis of a display optical system according to Numerical Example 3 of the present invention.

FIG. 12 is a cross-sectional view for illustrating a configuration of the finder optical system during mirror-up according to Numerical Example 3 of the present invention.

FIG. 13A is an exploded view along an optical axis of an observation optical system according to Numerical Example 3 of the present invention.

FIG. 13B is an exploded view along an optical axis of the display optical system according to Numerical Example 3 of the present invention.

FIG. 14 is a cross-sectional view for illustrating a configuration of a finder optical system according to Numerical Example 4 of the present invention.

FIG. 15 is a cross-sectional view for illustrating a configuration of the finder optical system during mirror-up according to Numerical Example 4 of the present invention.

FIG. 16A is an exploded view along an optical axis of an observation optical system according to Numerical Example 4 of the present invention.

FIG. 16B is an exploded view along an optical axis of the display optical system according to Numerical Example 4 of the present invention.

### DESCRIPTION OF THE EMBODIMENTS

Exemplary embodiments of the present invention are hereinafter described with reference to the drawings.

### First Embodiment

### (Optical Apparatus and Finder System)

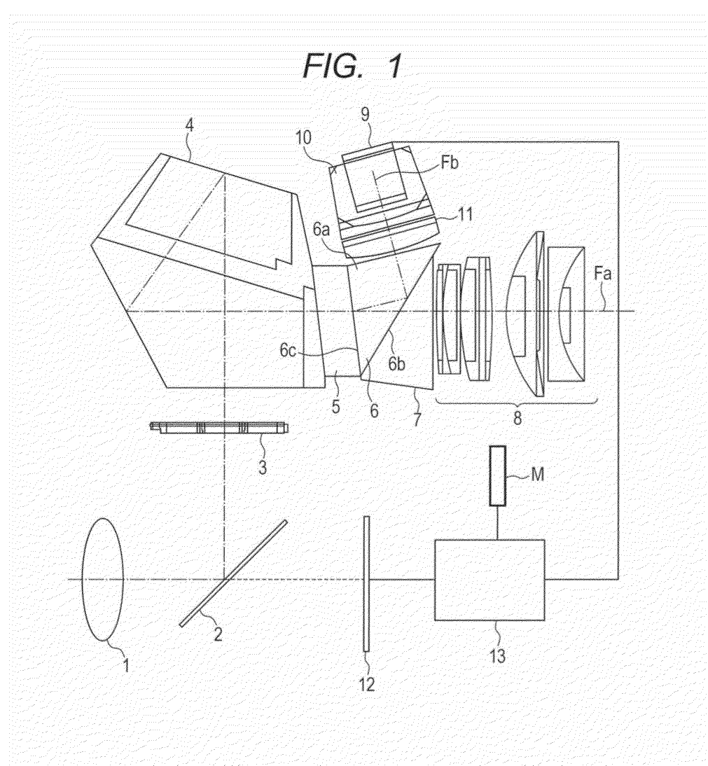

FIG. 1 is a schematic cross-sectional view of a single-lens reflex camera as an optical apparatus having a finder system mounted thereon according to an embodiment of the present invention. FIG. 1 is an illustration of a state in which a movable mirror 2 is located on an optical axis (Fa). Alight flux based on a subject image formed on a predetermined surface (diffusion surface) of a reticle 3 via a photographing lens (objective lens) 1 as an objective optical system and the movable mirror 2 passes through an erect image forming member 4, prisms 5, 6, and 7, and an eyepiece lens 8 as an eyepiece optical system to reach the eyes of an observer. The above-mentioned components serve as an observation optical system in the finder system.

On the other hand, light from a display member 9 configured to display information on photography passes through an optical member 10 and a first lens unit 11 as a lens unit having a positive refractive power, and then passes through an optical surface 6a that is a light input surface of the prism 6. After that, the light is reflected by two optical surfaces 6b (second optical surface) and 6c (first optical surface) of the prism 6 in the stated order, which are inclined in different directions with respect to the optical axis Fa of the observation optical system. The light is then transmitted through the optical surface 6b, and passes through the eyepiece lens 8 to reach the eyes of the observer, thereby enabling the observer to observe the information on photography in the same field of view as that of the subject image. The above-mentioned components serve as a display optical system in the finder system. The first lens unit 11 may be formed of a single positive lens, or may be formed of a plurality of lenses. The first lens unit 11 only needs to have a positive refractive power as a whole.

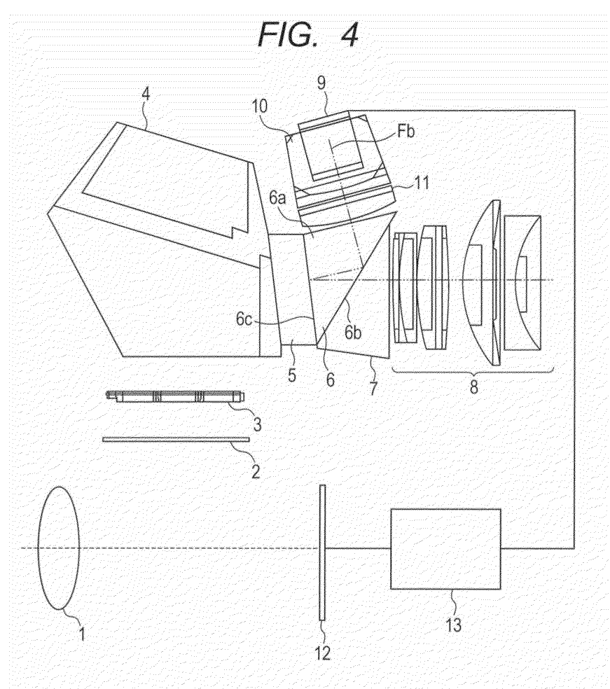

Now, FIG. 4 is an illustration of mirror-up of the finder optical system. The movable mirror 2, which is a rotatable reflective mirror, is retracted (mirror-up) from a photographing optical axis so that the subject image obtained through the photographing lens 1 is formed on an image pickup element 12. Then, an image from the image pickup element 12 is displayed on the display member 9 in a live view via a signal processing device 13. Note that, a monitor M may be arranged at a position outside a camera main body below an eyepiece unit of the finder system, and information from the image pickup element 12 may be displayed to the outside.

The image displayed on the display member 9 in a live view is enlarged by the first lens unit 11, and passes through the prisms 6 and 7 and the eyepiece lens 8 to reach the eyes of the observer. Viewing of photographed images and displaying of menus are also possible via the display member 9 after the mirror-up. In this manner, the camera as the optical apparatus having the finder system mounted thereon according to this embodiment enables the observer to observe the subject image formed on the reticle 3 as well as a subject image, photographed images, and various kinds of menus displayed in a live view through the same eyepiece lens.

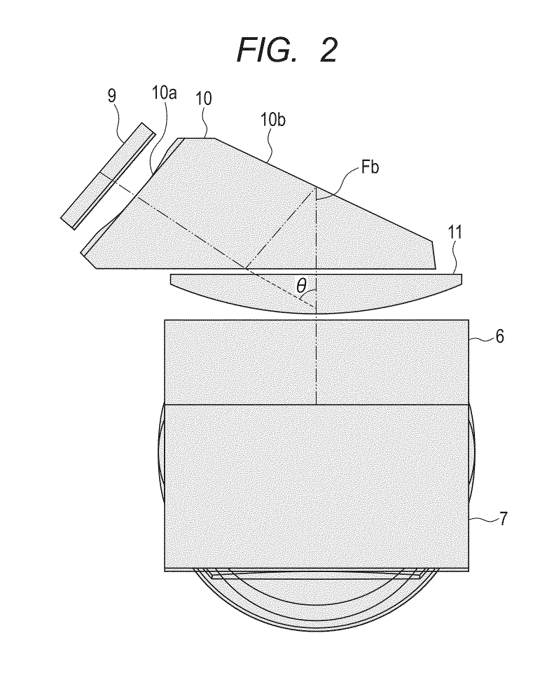

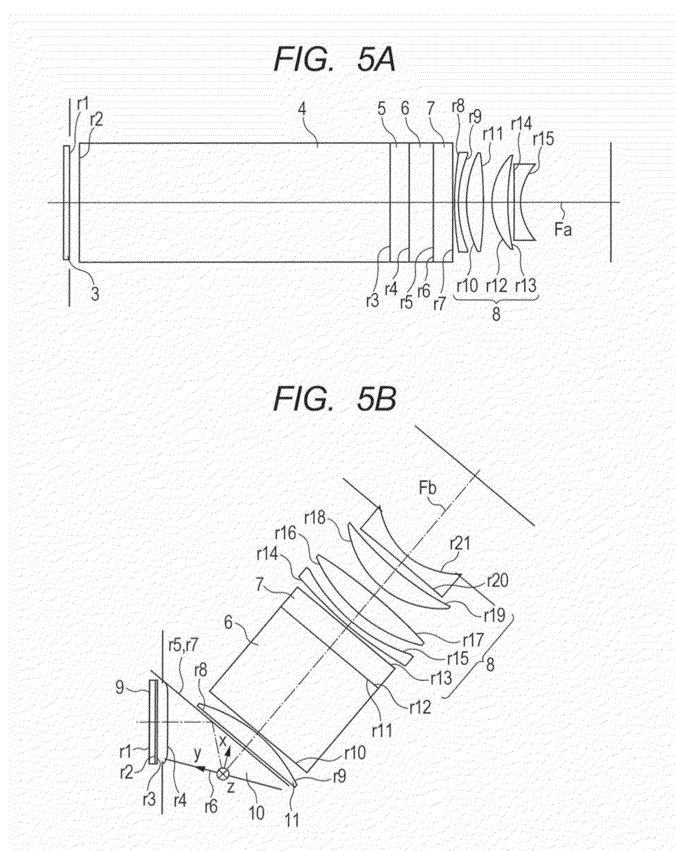

Now, FIG. 5A is an exploded view along the optical axis Fa of the observation optical system, and FIG. 5B is an exploded view along an optical axis Fb of the display optical system. Now, a specific configuration of the display optical system is illustrated in FIG. 2. FIG. 2 is a cross-sectional view including an optical path that extends from the display member 9 to the optical surfaces 6a and 6b of the prism 6 through the optical member 10 and the first lens unit 11 and that matches with the optical axis Fb of the display optical system. The optical member 10 has two reflection surfaces inside. The first reflection surface counted from the display member 9 is a total reflection surface, and the second reflection surface is a reflection surface formed by mirror evaporation. In this manner, a height position of the display member 9 can be suppressed to be small to prevent the finder system from being upsized in the height direction.

Neither of the optical axis Fa of the observation optical system and the optical axis Fb of the display optical system is included in the same plane. Specifically, in FIG. 1, the display member 9 and the optical member 10 are arranged in a depth direction of the drawing sheet. This arrangement prevents the display member 9 and another component (not shown) of the camera such as an accessory shoe from interfering with each other to upsize the camera in the height direction.

Further, in the finder system according to this embodiment, a focal length f₁ of the first lens unit 11 and a focal length f of the eyepiece lens 8 at −1 diopter satisfy Conditional Expression (1).

0.3<f₁/f<1.0 (1)

Conditional Expression (1) is a condition for enlargedly observing an image of the display member 9 with a wide angle of field while preventing the finder system from being upsized in the height direction. When f₁/f falls below Conditional Expression (1), the focal length of the first lens unit 11 is too short, and hence the distance between the display member 9 and the optical surface 6a of the prism 6 is too narrow. As a result, the internal reflection in the optical member 10 occurs only once, thus failing to optimize the position of the display member 9.

On the other hand, when f₁/f exceeds Conditional Expression (1), the focal length of the first lens unit is too long, and hence the distance between the display member 9 and the optical surface 6a of the prism 6 is too long. As a result, the display member 9 is too far from the observer, and the observer cannot see the image of the display member 9 with a wide angle of field.

Further, in the finder system according to this embodiment, when a diagonal length of the display member 9 is represented by L₁ and a diagonal length of the display member 9 on an observation surface is represented by L, the diagonal lengths L₁ and L satisfy Conditional Expression (2).

1.2<(f₁/f)×(L/L₁)<1.5 (2)

Conditional Expression (2) is a condition for enlargedly observing an image of the display member 9 with a wide angle of field while preventing the finder system from being upsized in the height direction. When (f₁/f)×(L/L₁) falls below Conditional Expression (2), the focal length of the first lens unit 11 is too short, and hence the distance between the display member 9 and the optical surface 6a of the prism 6 is too narrow. As a result, the internal reflection in the optical member 10 occurs only once, thus failing to optimize the position of the display member 9. On the other hand, when (f₁/f)×(L/L₁) exceeds Conditional Expression (2), the focal length of the first lens unit is too long, and hence the distance between the display member 9 and the optical surface 6a of the prism 6 is too long. As a result, the display member 9 is too far from the observer, and the observer cannot see the image of the display member 9 with a wide angle of field.

Further, in the finder system according to this embodiment, the angle formed between the normal to the display member 9 and the central axis of the first lens unit 11 is represented by θ, the angle θ satisfies Conditional Expression (3).

40°<θ<75° (3)

Conditional Expression (3) is a condition for preventing the finder system from being upsized in the height direction. When θ falls below Conditional Expression (3), the light beam from the display member 9 cannot satisfy the condition of total reflection on an optical surface 10a (FIG. 2) that is a light input surface of the optical member 10. On the other hand, when θ exceeds Conditional Expression (3), the distance from the display member 9 to the optical surface 10a is too long, and hence the finder system is upsized.

Further, in the finder system according to this embodiment, an optical surface 10b (FIG. 2) of the optical member 10 is a rotationally asymmetrical aspherical surface, and hence the power of the first lens unit 11 can be suppressed to thin the first lens unit 11. Further, the rotationally asymmetrical aspherical surface is desired because astigmatism and distortion that occur in the display optical system can be suppressed.

The optical surface 6c (first optical surface) of the prism 6 serves as a half mirror or a dichroic mirror. The optical surface 6b (second optical surface) of the prism 6 may serve as a half mirror or a dichroic mirror, but the following is preferred.

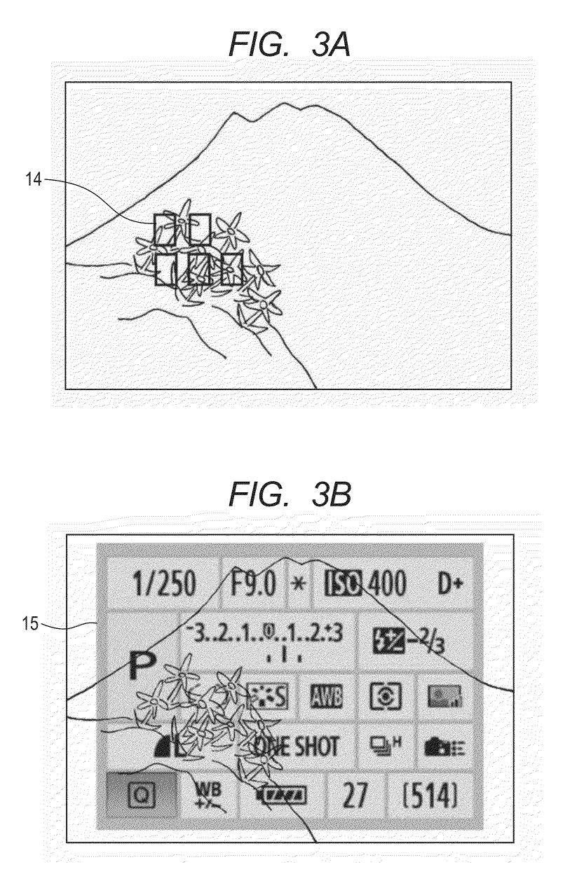

Specifically, an air gap of from approximately 10 μm to approximately 100 μm is formed between the prisms 6 and 7 so that a light beam from the optical surface 6a is totally reflected but a light beam reflected from the optical surface 6c enters the optical surface 6b at less than a critical angle and is transmitted through the optical surface 6b, and hence light beam loss can be minimized. As a result, the optical finder can be maintained bright, and as illustrated in FIG. 3A, visibility is good even when a red range-finding frame 14 is displayed in a superimposed manner. Further, as illustrated in FIG. 3B, various kinds of menu display 15 may be displayed in a superimposed manner.

### NUMERICAL EXAMPLES

Now, Numerical Examples of the present invention are described. Note that, in the values described below, ω represents an apparent field of view (half angle of field) at −1 diopter (standard diopter). Further, in the values indicating lens data, “ri” represents a paraxial radius of curvature of the i-th surface counted from an object side with reference to the reticle, and “di” represents an axial surface distance between the i-th surface and the (i+1)th surface counted from the object side.

Further, “Ni” represents a refractive index for d-line (wavelength=578.6 nm) of the i-th glass material counted from the object side, and “νi” represents an Abbe number for d-line of the i-th glass material counted from the object side. Note that, in the values described below, the unit of the length described is [mm] unless otherwise specified. However, the same optical characteristic of the optical system can be obtained even when the values are proportionally enlarged or proportionally reduced, and hence the unit is not limited to [mm] and may be another appropriate unit. Note that, in each of Numerical Examples, the surfaces described as “Rotationally Symmetric Aspherical Surface” in the field of “Parasitic Curvature Radius” have a rotationally symmetric aspherical shape defined by Expression 1.

$$x = \frac{\frac{{h}^{2}}{R}}{1 + \sqrt{1 - ( 1 + k ) {( \frac{h}{R} )}^{2}}} + {c}_{2} {h}^{2} + {c}_{4} {h}^{4} + {c}_{6} {h}^{6} + {c}_{8} {h}^{8} + {c}_{10} {h}^{10} \qquad ( Expression 1 )$$

Note that, in the above expression (Expression 1), x represents a distance from the apex of the lens surface in the optical axis direction, h represents a height in the direction perpendicular to the optical axis, R represents a paraxial radius of curvature at the apex of the lens surface, k represents a conic constant, and c₂, c₄, c₆, c₈, and c₁₀ represent polynomial coefficients. In the values indicating aspherical coefficients, “E−i” represents an exponential notation using 10 as its base, that is, “10⁻ⁱ”.

Further, in each of Numerical Examples, the surfaces described as “Rotationally Asymmetric Aspherical Surface” in the field of “Parasitic Curvature Radius” have a rotationally asymmetric aspherical shape defined by Expression 2.

x=c₂₀y²+c₀₂z²+c₃₀y³+c₁₂yz²+c₄₀y⁴+c₂₂y²z²+c₀₄z⁴+c₅₀y⁵+c₃₂y³z²+c₃₄yz⁴+c₆₀y⁶+c₄₂y⁴z²+c₂₄y²z⁴+c₀₆z⁶+c₇₀y⁷+c₅₂y⁵z²+c₃₄y³z⁴+c₁₆yz⁶+c₈₀y⁸+c₆₂y⁶z²+c₄₄y⁴z⁴+c₂₆y²z⁶+c₀₈z⁸+c₉₀y⁹+c₇₂y⁷z²+c₅₄y⁵z⁴+c₃₆y³z⁶+c₁₈yz⁸+c₁₀₀y¹⁰+c₈₂y⁸z²+c₆₄y⁶z⁴+c₄₆y⁴z⁶+c₂₈y²z⁸+c₀₁₀z¹⁰ (Expression 2)

Note that, in Expression 2, as illustrated in FIG. 5B, x represents a height in the direction perpendicular to the rotationally asymmetric aspherical surface from an intersection between the optical axis Fb and the rotationally asymmetric aspherical surface, y represents a height in the direction parallel to the drawing sheet and perpendicular to the x axis, and z represents a height in the direction perpendicular to the drawing sheet. Further, c₂₀, c₀₂, c₃₀, c₁₂, . . . represent polynomial coefficients. In the values indicating aspherical coefficients, “E−i” represents an exponential notation using 10 as its base, that is, “10⁻ⁱ”.

### Numerical Example 1

(Eyepiece optical system entire data)

| Image display surface | |
|---|---|
| diagonal length L | ω |
| 26.10 | 28.02° |

(Lens data)

| Paraxial | | | |
|---|---|---|---|
| radius of | Axial surface | Refractive | Abbe number |
| curvature | distance | index (Nd) | (νd) |
| r1 = ∞ | d1 = 5.00 | | |
| r2 = ∞ | d2 = 81.67 | N2 = 1.66 | ν2 = 50.88 |
| r3 = ∞ | d3 = 5.00 | N3 = 1.66 | ν3 = 50.88 |
| r4 = ∞ | d4 = 6.40 | N4 = 1.66 | ν4 = 50.88 |
| r5 = ∞ | d5 = 0.03 | | |
| r6 = ∞ | d6 = 4.94 | N6 = 1.66 | ν6 = 50.88 |
| r7 = ∞ | d7 = 0.50 | | |
| r8 = 84.28 | d8 = 1.00 | N8 = 1.85 | ν8 = 23.78 |
| r9 = 34.13 | d9 = Variable | | |
| r10 = 30.26 | d10 = 4.55 | N10 = 1.80 | ν10 = 46.58 |
| r11 = −83.05 | d11 = Variable | | |
| r12 = 17.93 | d12 = 4.22 | N12 = 1.80 | ν12 = 46.58 |
| r13 = 61.45 | d13 = 1.72 | | |
| r14 = 2,249.95 | d14 = 1.60 | N14 = 1.80 | ν14 = 34.97 |
| r15 = 14.49 | d15 = 24.00 | | |

(Variable distance)

| | | | |
|---|---|---|---|
| Diopter | −1.00 | −3.00 | +1.00 |
| d9 | 2.11 | 0.50 | 3.76 |
| d11 | 2.10 | 3.71 | 0.45 |

(Display optical system entire data)

| Image display surface | |
|---|---|
| diagonal length L1 | ω |
| 12.29 | 29.02° |

(Lens data)

| Paraxial radius | Axial surface | Refractive | Abbe number |
|---|---|---|---|
| of curvature | distance | index (Nd) | (νd) |
| r1 = ∞ | d1 = 1.20 | N1 = 1.52 | ν1 = 64.14 |
| r2 = ∞ | d2 = 0.22 | N2 = 1.52 | ν2 = 58.60 |
| r3 = ∞ | d3 = 1.84 | | |
| r4 = Rotationally | d4 = 8.80 | N4 = 1.57 | ν4 = 34.00 |
| symmetric | | | |
| aspherical | | | |
| surface | | | |
| r5 = ∞ | d5 = 10.03 | N5 = 1.57 | ν5 = 34.00 |
| r6 = Rotationally | d6 = 6.45 | N6 = 1.57 | ν6 = 34.00 |
| asymmetric | | | |
| aspherical | | | |
| surface | | | |
| r7 = ∞ | d7 = 0.40 | | |
| r8 = ∞ | d8 = 3.15 | N8 = 1.85 | ν8 = 40.39 |
| r9 = Rotationally | d9 = 0.40 | | |
| symmetric | | | |
| aspherical | | | |
| surface | | | |
| r10 = ∞ | d10 = 20.91 | N10 = 1.66 | ν10 = 50.88 |
| r11 = ∞ | d11 = 0.03 | | |
| r12 = ∞ | d12 = 4.94 | N12 = 1.66 | ν12 = 50.88 |
| r13 = ∞ | d13 = 0.50 | | |
| r14 = 84.28 | d14 = 1.00 | N14 = 1.85 | ν14 = 23.78 |
| r15 = 34.13 | d15 = Variable | | |
| r16 = 30.26 | d16 = 4.55 | N16 = 1.80 | ν16 = 46.58 |
| r17 = −83.05 | d17 = Variable | | |
| r18 = 17.93 | d18 = 4.22 | N18 = 1.80 | ν18 = 46.58 |
| r19 = 61.45 | d19 = 1.72 | | |
| r20 = 2,249.95 | d20 = 1.60 | N20 = 1.80 | ν20 = 34.97 |
| r21 = 14.49 | d21 = 24.00 | | |

(Aspherical coefficient)

| | R | k | c2 | c4 | c6 | c8 | c10 |
|---|---|---|---|---|---|---|---|
| r4 | 106.50 | −9.15 | 0.00 | 1.25E−04 | −5.55E−06 | 0.00 | 0.00 |
| r9 | −28.05 | −6.20 | 0.00 | −3.07E−05 | 6.52E−08 | 1.59E−10 | −5.42E−13 |

| | c20 | c02 |
|---|---|---|
| r6 | −1.11E−03 | −1.37E−03 |
| | c30 | c12 |
| r6 | −1.59E−05 | −4.34E−05 |

| | c40 | c22 | c04 |
|---|---|---|---|
| r6 | 1.55E−06 | 1.18E−06 | 3.50E−06 |
| | c50 | c32 | c14 |
| r6 | 6.29E−09 | 1.91E−08 | 9.49E−08 |

| | c60 | c42 | c24 | c06 |
|---|---|---|---|---|
| r6 | 3.96E−09 | 6.09E−08 | 1.96E−08 | −1.50E−08 |
| | c70 | c52 | c34 | c16 |
| r6 | 1.70E−09 | 7.60E−09 | 9.30E−09 | 2.60E−09 |

| | c80 | c62 | c44 | c26 | c08 |
|---|---|---|---|---|---|
| r6 | 2.54E−10 | 3.45E−10 | 2.29E−09 | 8.49E−10 | 6.86E−10 |
| | c90 | c72 | c54 | c36 | c18 |
| r6 | −3.05E−12 | −4.07E−11 | −4.88E−12 | −8.18E−11 | 8.16E−12 |

| | c100 | c82 | c64 | c46 | c28 | c010 |
|---|---|---|---|---|---|---|
| r6 | −1.00E−12 | −2.65E−12 | −8.72E−12 | −1.74E−11 | −2.15E−12 | −3.92E−12 |

(Variable distance)

| | | | |
|---|---|---|---|
| Diopter | −1.00 | −3.00 | +1.00 |
| d15 | 2.11 | 0.50 | 3.76 |
| d17 | 2.10 | 3.71 | 0.45 |

(Conditional Expression)

| Conditional Expression | Value |
|---|---|
| f1/f | 0.61 |
| (f1/f) × (L/L1) | 1.34 |
| θ | 50° |

### Second Embodiment

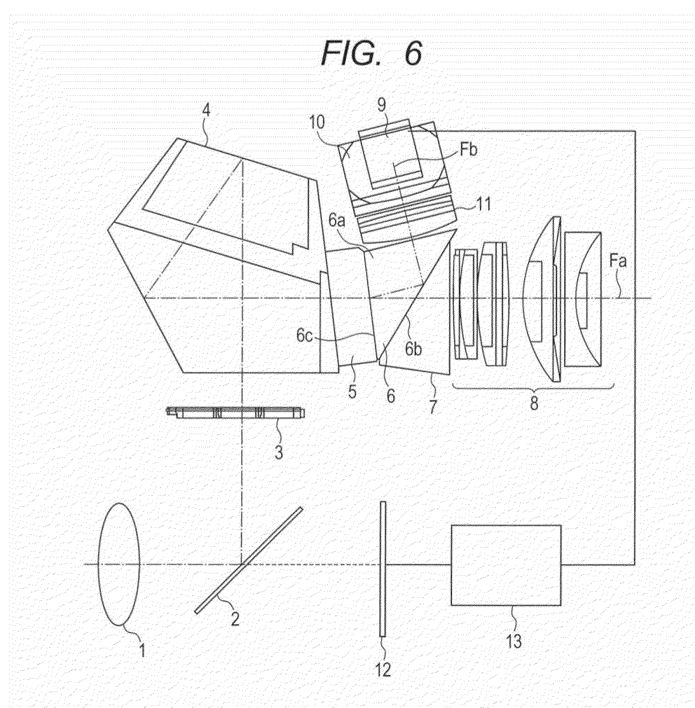

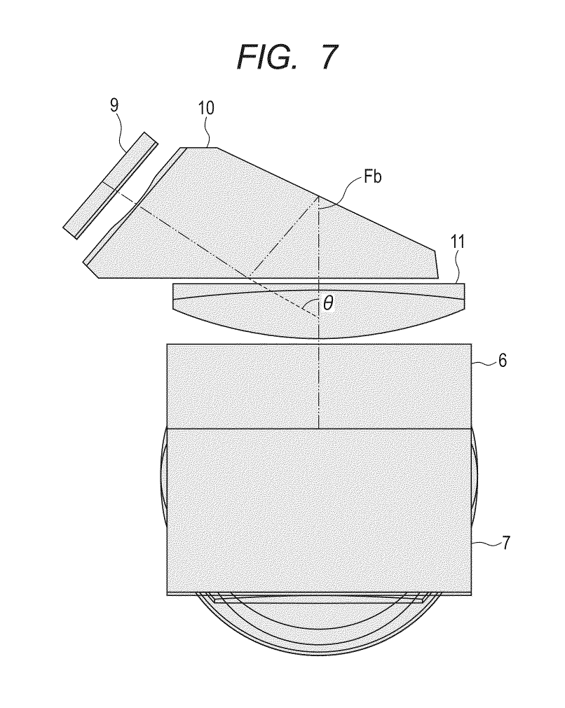

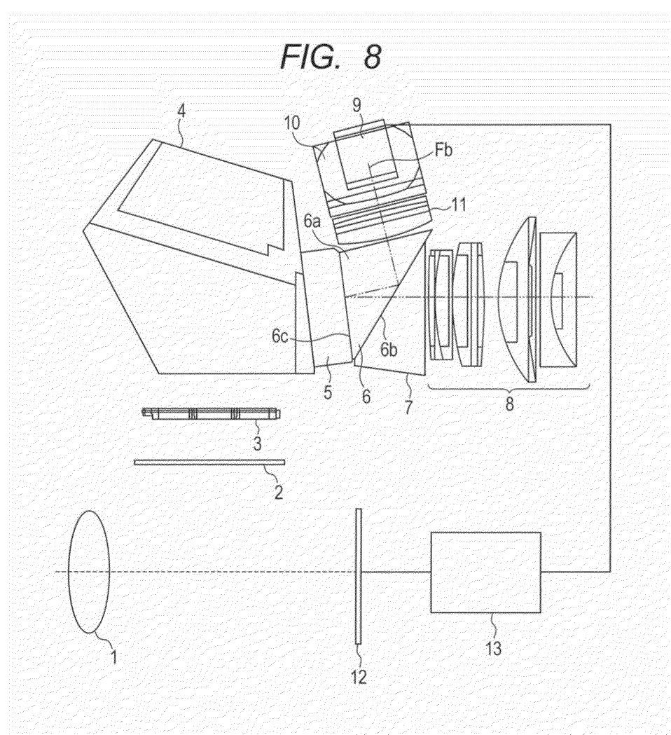

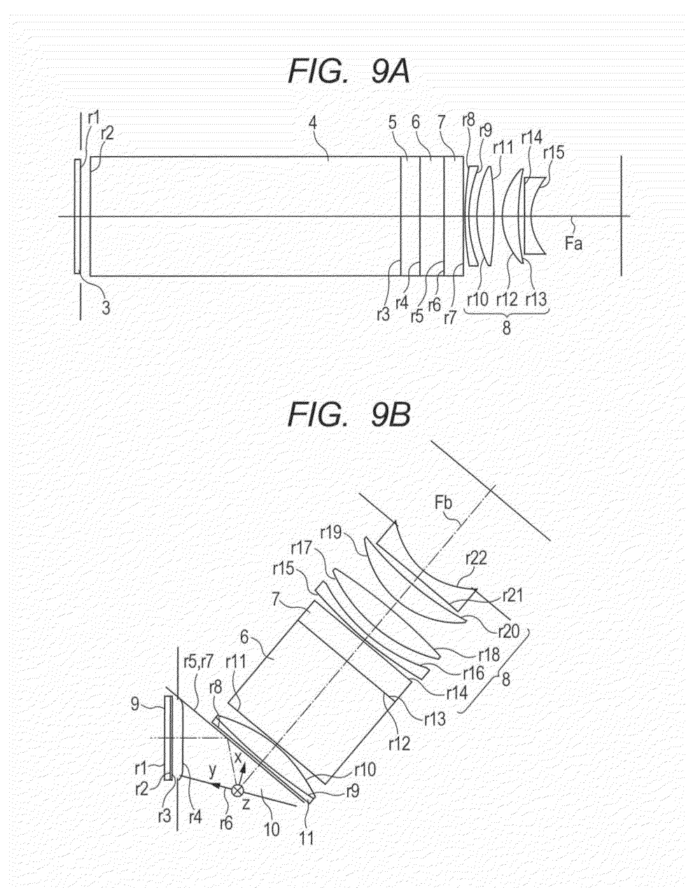

FIG. 6 is a cross-sectional view for illustrating a configuration of a finder optical system according to Numerical Example 2 of the present invention. Further, FIG. 7 is a cross-sectional view parallel to an optical axis of a display optical system according to this embodiment. FIG. 8 is a cross-sectional view for illustrating a configuration of the finder optical system during mirror-up. Further, FIG. 9A and FIG. 9B are exploded views along optical axes of an observation optical system and the display optical system, respectively.

### Numerical Example 2

(Eyepiece optical system entire data)

| Image display surface | |
|---|---|
| diagonal length L | ω |
| 26.10 | 28.02° |

(Lens data)

| Paraxial | | | |
|---|---|---|---|
| radius of | Axial surface | Refractive | |
| curvature | distance | index (Nd) | Abbe number (νd) |
| r1 = ∞ | d1 = 5.00 | | |
| r2 = ∞ | d2 = 81.67 | N2 = 1.66 | ν2 = 50.88 |
| r3 = ∞ | d3 = 5.00 | N3 = 1.66 | ν3 = 50.88 |
| r4 = ∞ | d4 = 6.40 | N4 = 1.66 | ν4 = 50.88 |
| r5 = ∞ | d5 = 0.03 | | |
| r6 = ∞ | d6 = 4.94 | N6 = 1.66 | ν6 = 50.88 |
| r7 = ∞ | d7 = 0.50 | | |
| r8 = 84.28 | d8 = 1.00 | N8 = 1.85 | ν8 = 23.78 |
| r9 = 34.13 | d9 = Variable | | |
| r10 = 30.26 | d10 = 4.55 | N10 = 1.80 | ν10 = 46.58 |
| r11 = −83.05 | d11 = Variable | | |
| r12 = 17.93 | d12 = 4.22 | N12 = 1.80 | ν12 = 46.58 |
| r13 = 61.45 | d13 = 1.72 | | |
| r14 = 2,249.95 | d14 = 1.60 | N14 = 1.80 | ν14 = 34.97 |
| r15 = 14.49 | d15 = 24.00 | | |

(Variable distance)

| | | | |
|---|---|---|---|
| Diopter | −1.00 | −3.00 | +1.00 |
| d9 | 2.11 | 0.50 | 3.76 |
| d11 | 2.10 | 3.71 | 0.45 |

(Display optical system entire data)

| Image display surface | |
|---|---|
| diagonal length L1 | ω |
| 12.29 | 28.61° |

(Lens data)

| Paraxial radius | Axial surface | Refractive | Abbe number |
|---|---|---|---|
| of curvature | distance | index (Nd) | (νd) |
| r1 = ∞ | d1 = 1.20 | N1 = 1.52 | ν1 = 64.14 |
| r2 = ∞ | d2 = 0.22 | N2 = 1.52 | ν2 = 58.60 |
| r3 = ∞ | d3 = 1.84 | | |
| r4 = Rotationally | d4 = 8.80 | N4 = 1.57 | ν4 = 34.00 |
| symmetric | | | |
| aspherical | | | |
| surface | | | |
| r5 = ∞ | d5 = 10.03 | N5 = 1.57 | ν5 = 34.00 |
| r6 = Rotationally | d6 = 6.45 | N6 = 1.57 | ν6 = 34.00 |
| asymmetric | | | |
| aspherical | | | |
| surface | | | |
| r7 = ∞ | d7 = 0.40 | | |
| r8 = ∞ | d8 = 0.50 | N8 = 1.85 | ν8 = 23.78 |
| r9 = 79.82 | d9 = 3.90 | N9 = 1.85 | ν9 = 40.39 |
| r10 = Rotationally | d10 = 0.40 | | |
| symmetric | | | |
| aspherical | | | |
| surface | | | |
| r11 = ∞ | d11 = 20.91 | N11 = 1.66 | ν11 = 50.88 |
| r12 = ∞ | d12 = 0.03 | | |
| r13 = ∞ | d13 = 4.94 | N13 = 1.66 | ν13 = 50.88 |
| r14 = ∞ | d14 = 0.50 | | |
| r15 = 84.28 | d15 = 1.00 | N15 = 1.85 | ν15 = 23.78 |
| r16 = 34.13 | d16 = Variable | | |
| r17 = 30.26 | d17 = 4.55 | N17 = 1.80 | ν17 = 46.58 |
| r18 = −83.05 | d18 = Variable | | |
| r19 = 17.93 | d19 = 4.22 | N19 = 1.80 | ν19 = 46.58 |
| r20 = 61.45 | d20 = 1.72 | | |
| r21 = 2,249.95 | d21 = 1.60 | N21 = 1.80 | ν21 = 34.97 |
| r22 = 14.49 | d22 = 24.00 | | |

(Aspherical coefficient)

| | R | k | c2 | c4 | c6 | c8 | c10 |
|---|---|---|---|---|---|---|---|
| r4 | 58.70 | −9.22 | 0.00 | −1.28E−04 | −2.19E−06 | 0.00 | 0.00 |
| r10 | −29.13 | −6.05 | 0.00 | −2.50E−05 | 5.71E−08 | 1.38E−10 | −7.99E−13 |

| | c20 | c02 |
|---|---|---|
| r6 | −1.22E−03 | −1.50E−03 |
| | c30 | c12 |
| r6 | −1.69E−05 | −4.76E−05 |

| | c40 | c22 | c04 |
|---|---|---|---|
| r6 | 3.51E−06 | 6.23E−06 | 6.25E−06 |
| | c50 | c32 | c14 |
| r6 | 6.82E−08 | 2.80E−07 | 3.16E−07 |

| | c60 | c42 | c24 | c06 |
|---|---|---|---|---|
| r6 | 5.93E−09 | 5.09E−08 | 2.72E−08 | −1.14E−08 |
| | c70 | c52 | c34 | c16 |
| r6 | 1.63E−09 | 5.34E−09 | 7.00E−09 | −4.32E−10 |

| | c80 | c62 | c44 | c26 | c08 |
|---|---|---|---|---|---|
| r6 | 1.67E−10 | 6.95E−11 | 2.20E−09 | −2.16E−10 | 4.94E−10 |
| | c90 | c72 | c54 | c36 | c18 |
| r6 | −6.64E−12 | −4.54E−11 | −1.04E−11 | −9.09E−11 | 2.46E−11 |

| | c100 | c82 | c64 | c46 | c28 | c010 |
|---|---|---|---|---|---|---|
| r6 | −9.60E−13 | −2.12E−12 | −1.18E−11 | 1.60E−11 | 3.19E−12 | 3.35E−12 |

(Variable distance)

| | | | |
|---|---|---|---|
| Diopter | −1.00 | −3.00 | +1.00 |
| d15 | 2.11 | 0.50 | 3.76 |
| d17 | 2.10 | 3.71 | 0.45 |

(Conditional Expression)

| Conditional Expression | Value |
|---|---|
| f1/f | 0.63 |
| (f1/f) × (L/L1) | 1.39 |
| θ | 50° |

### Third Embodiment

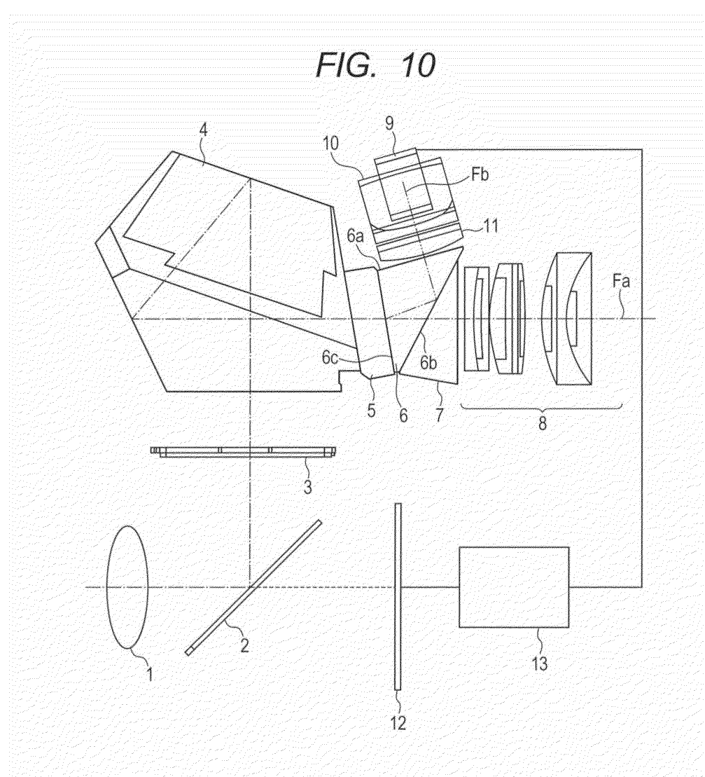

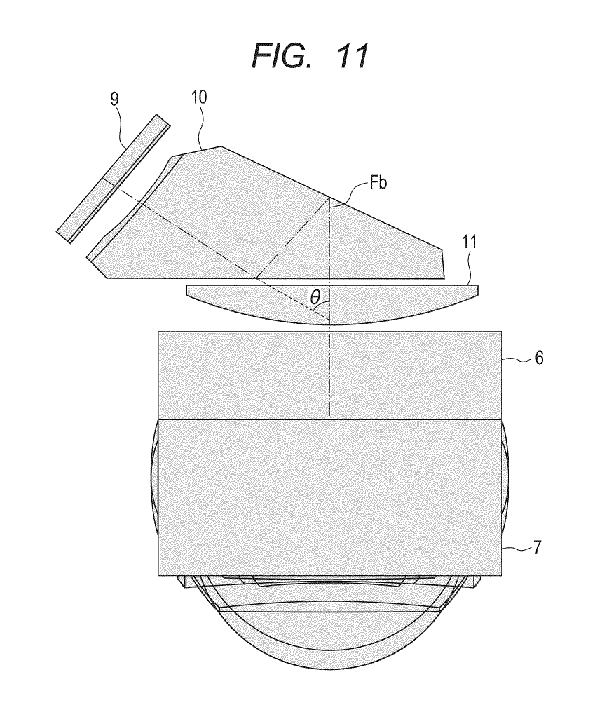

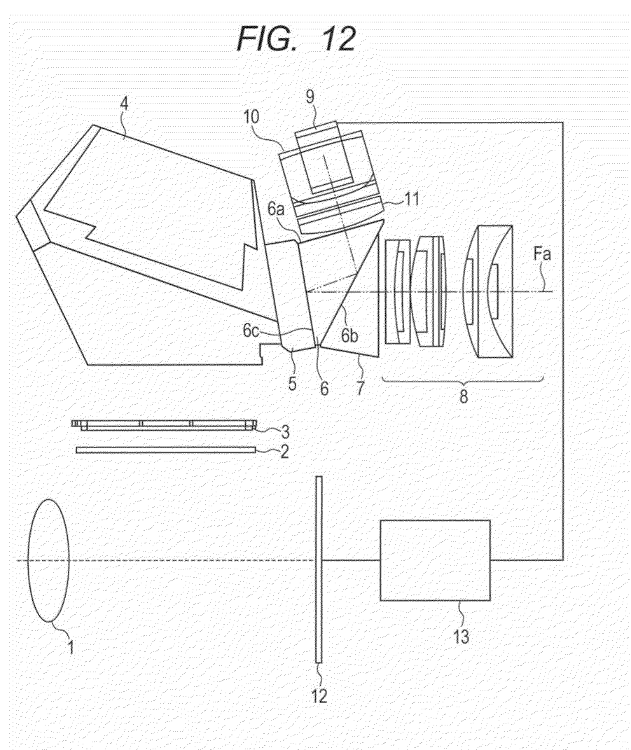

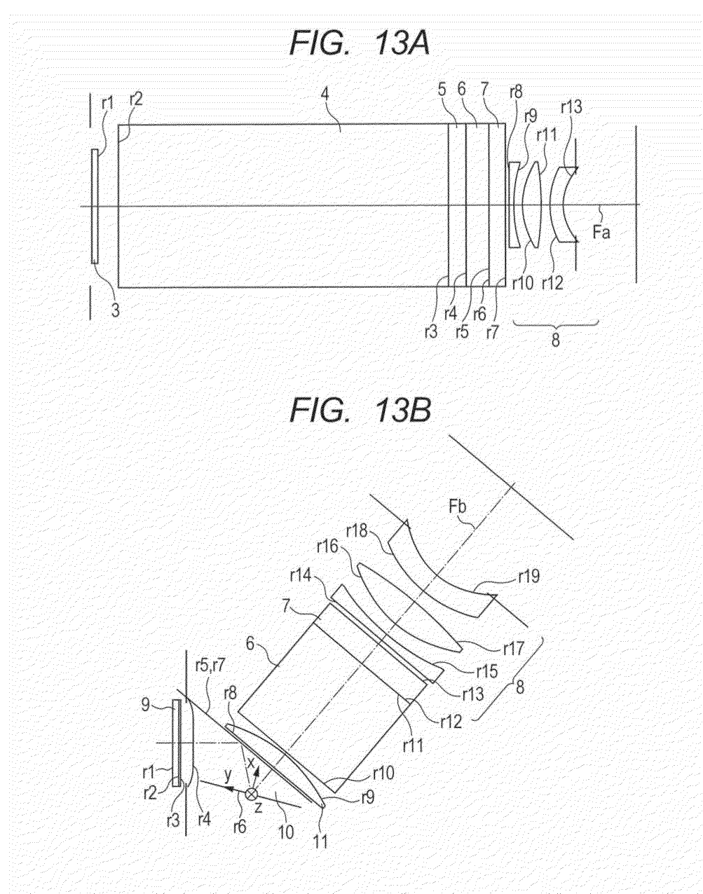

FIG. 10 is a cross-sectional view for illustrating a configuration of a finder optical system according to Numerical Example 3 of the present invention. Further, FIG. 11 is a cross-sectional view parallel to an optical axis of a display optical system according to this embodiment and FIG. 12 is a cross-sectional view for illustrating a configuration of the finder optical system during mirror-up. Further, FIG. 13A and FIG. 13B are exploded views along optical axes of an observation optical system and the display optical system, respectively.

### Numerical Example 3

(Eyepiece optical system entire data)

| Image display surface | |
|---|---|
| diagonal length L | ω |
| 42.23 | 33.17° |

(Lens data)

| Paraxial radius | Axial surface | Refractive | |
|---|---|---|---|
| of curvature | distance | index (Nd) | Abbe number (νd) |
| r1 = ∞ | d1 = 7.82 | | |
| r2 = ∞ | d2 = 93.23 | N2 = 1.66 | ν2 = 50.88 |
| r3 = ∞ | d3 = 5.00 | N3 = 1.66 | ν3 = 50.88 |
| r4 = ∞ | d4 = 6.33 | N4 = 1.66 | ν4 = 50.88 |
| r5 = ∞ | d5 = 0.03 | | |
| r6 = ∞ | d6 = 4.64 | N6 = 1.66 | ν6 = 50.88 |
| r7 = ∞ | d7 = 0.97 | | |
| r8 = −1,779.62 | d8 = 1.30 | N8 = 1.85 | ν8 = 23.78 |
| r9 = 39.84 | d9 = Variable | | |
| r10 = Rotationally | d10 = 5.39 | N10 = 1.69 | ν10 = 53.20 |
| symmetric | | | |
| aspherical | | | |
| surface | | | |
| r11 = −69.26 | d11 = Variable | | |
| r12 = 23.36 | d12 = 3.73 | N12 = 1.80 | ν12 = 46.58 |
| r13 = 15.04 | d13 = 21.00 | | |

(Aspherical coefficient)

| | R | k | c2 | c4 | c6 | c8 |
|---|---|---|---|---|---|---|
| r10 | 20.03 | −1.22 | 0.00 | −5.58E−07 | −3.33E−09 | 4.53E−12 |

(Variable distance)

| | | | |
|---|---|---|---|
| Diopter | −1.00 | −3.00 | +1.00 |
| d9 | 2.49 | 0.80 | 4.41 |
| d11 | 2.42 | 4.11 | 0.50 |

(Display optical system entire data)

| Image display surface | |
|---|---|
| diagonal length L1 | ω |
| 12.29 | 26.60° |

(Lens data)

| Paraxial radius | Axial surface | Refractive | Abbe number |
|---|---|---|---|
| of curvature | distance | index (Nd) | (νd) |
| r1 = ∞ | d1 = 1.20 | N1 = 1.52 | ν1 = 64.14 |
| r2 = ∞ | d2 = 0.22 | N2 = 1.52 | ν2 = 58.60 |
| r3 = ∞ | d3 = 2.21 | | |
| r4 = Rotationally | d4 = 8.80 | N4 = 1.57 | ν4 = 34.00 |
| symmetric | | | |
| aspherical | | | |
| surface | | | |
| r5 = ∞ | d5 = 9.50 | N5 = 1.57 | ν5 = 34.00 |
| r6 = Rotationally | d6 = 6.10 | N6 = 1.57 | ν6 = 34.00 |
| asymmetric | | | |
| aspherical | | | |
| surface | | | |
| r7 = ∞ | d7 = 0.40 | | |
| r8 = ∞ | d8 = 3.10 | N8 = 1.85 | ν8 = 40.39 |
| r9 = Rotationally | d9 = 0.40 | | |
| symmetric | | | |
| aspherical | | | |
| surface | | | |
| r10 = ∞ | d10 = 21.31 | N10 = 1.66 | ν10 = 50.88 |
| r11 = ∞ | d11 = 0.03 | | |
| r12 = ∞ | d12 = 4.64 | N12 = 1.66 | ν12 = 50.88 |
| r13 = ∞ | d13 = 0.97 | | |
| r14 = −1,779.62 | d14 = 1.30 | N14 = 1.85 | ν14 = 23.78 |
| r15 = 39.84 | d15 = Variable | | |
| r16 = Rotationally | d16 = 5.39 | N16 = 1.69 | ν16 = 53.20 |
| symmetric | | | |
| aspherical | | | |
| surface | | | |
| r17 = −69.26 | d17 = Variable | | |
| r18 = 23.36 | d18 = 3.73 | N18 = 1.80 | ν18 = 46.58 |
| r19 = 15.04 | d19 = 21.00 | | |

(Aspherical coefficient)

| | R | k | c2 | c4 | c6 | c8 | c10 |
|---|---|---|---|---|---|---|---|
| r4 | 642.46 | −1.04E+01 | 0.00 | −6.50E−05 | −2.46E−06 | 0.00 | 0.00 |
| r9 | −27.48 | −6.77 | 0.00 | −3.54E−05 | 1.09E−07 | −8.80E−11 | −4.54E−13 |
| r16 | 20.03 | −1.22 | 0.00 | −5.58E−07 | −3.33E−09 | −4.53E−12 | 0.00 |

| | c20 | c02 |
|---|---|---|
| r6 | −5.99E−05 | −7.04E−05 |
| | c30 | c12 |
| r6 | −2.12E−07 | 1.72E−07 |

| | c40 | c22 | c04 |
|---|---|---|---|
| r6 | 2.78E−06 | 3.75E−06 | 4.25E−06 |
| | c50 | c32 | c14 |
| r6 | 6.09E−08 | −6.06E−09 | 8.07E−08 |

| | c60 | c42 | c24 | c06 |
|---|---|---|---|---|
| r6 | 7.73E−10 | 3.77E−08 | 3.06E−08 | −9.31E−09 |
| | c70 | c52 | c34 | c16 |
| r6 | 6.18E−10 | 4.66E−09 | −5.76E−10 | −9.31E−09 |

| | c80 | c62 | c44 | c26 | c08 |
|---|---|---|---|---|---|
| r6 | 1.34E−10 | 2.79E−10 | −4.64E−10 | 1.32E−09 | 4.73E−10 |
| | c90 | c72 | c54 | c36 | c18 |
| r6 | −1.21E−12 | −7.69E−12 | −1.12E−10 | 1.46E−10 | −1.44E−10 |

| | c100 | c82 | c64 | c46 | c28 | c010 |
|---|---|---|---|---|---|---|
| r6 | −6.42E−13 | −1.89E−12 | −5.99E−12 | 9.38E−12 | −2.13E−11 | 3.83E−12 |

(Variable distance)

| | | | |
|---|---|---|---|
| Diopter | −1.00 | −3.00 | +1.00 |
| d15 | 2.49 | 0.80 | 4.41 |
| d17 | 2.42 | 4.11 | 0.50 |

(Conditional Expression)

| Conditional Expression | Value |
|---|---|
| f1/f | 0.43 |
| (f1/f) × (L/L1) | 1.46 |
| θ | 50° |

### Fourth Embodiment

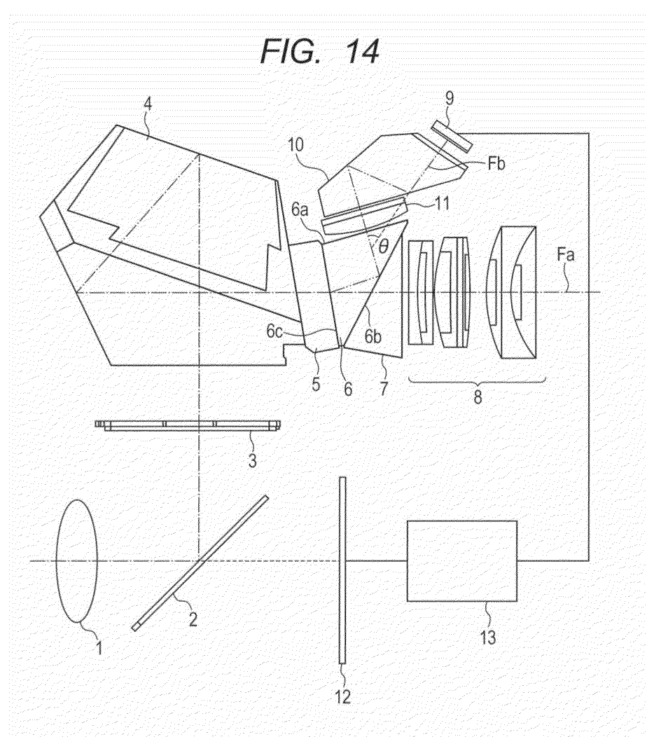

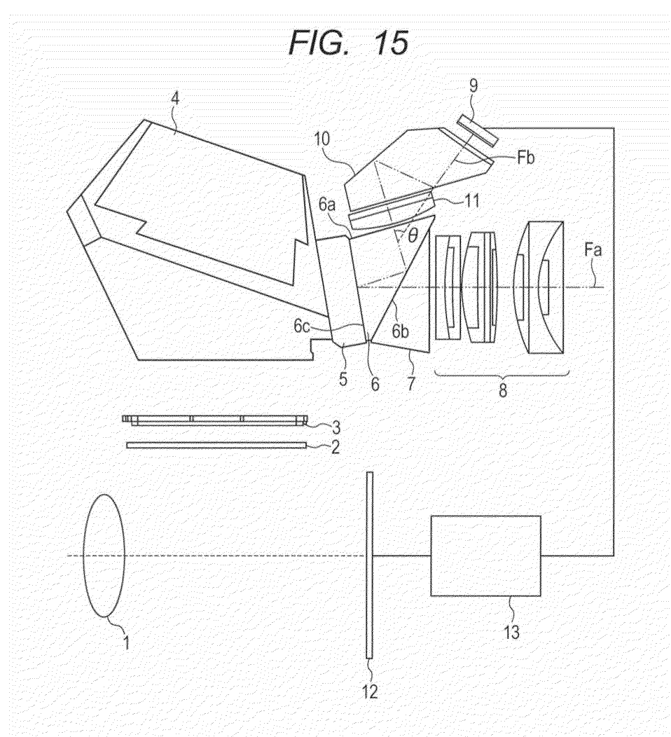

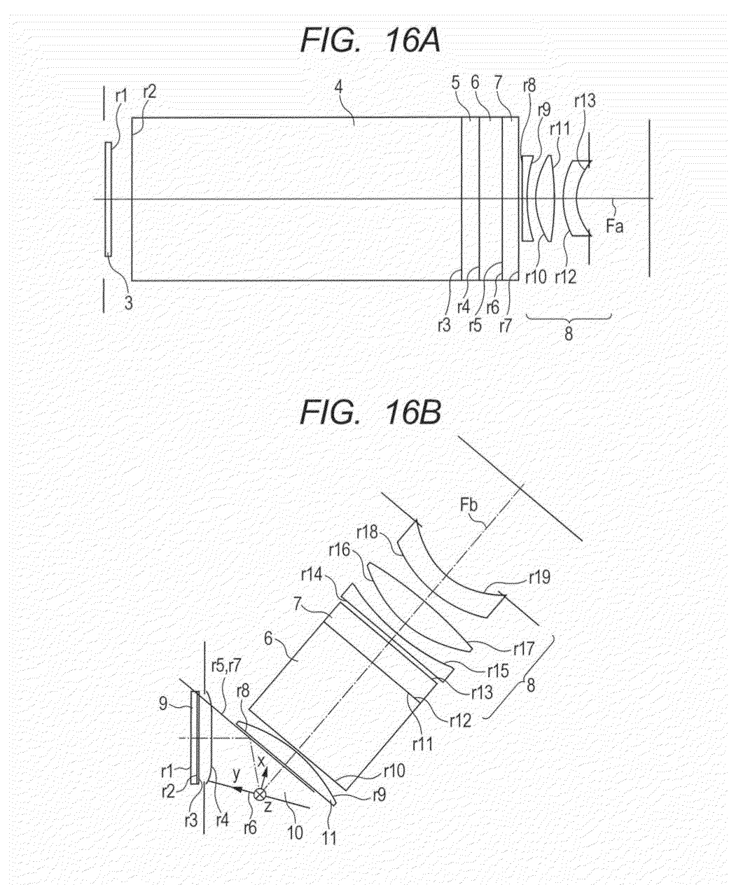

FIG. 14 is a cross-sectional view for illustrating a configuration of a finder optical system according to Numerical Example 4 of the present invention. Further, FIG. 15 is a cross-sectional view for illustrating a configuration of the finder optical system during mirror-up and FIG. 16A and FIG. 16B are exploded views along optical axes of an observation optical system and a display optical system, respectively.

### Numerical Example 4

(Eyepiece optical system entire data)

| Image display surface | |
|---|---|
| diagonal length L | ω |
| 42.23 | 33.17° |

(Lens data)

| Paraxial radius | Axial surface | Refractive | Abbe number |
|---|---|---|---|
| of curvature | distance | index (Nd) | (νd) |
| r1 = ∞ | d1 = 7.82 | | |
| r2 = ∞ | d2 = 93.23 | N2 = 1.66 | ν2 = 50.88 |
| r3 = ∞ | d3 = 5.00 | N3 = 1.66 | ν3 = 50.88 |
| r4 = ∞ | d4 = 6.33 | N4 = 1.66 | ν4 = 50.88 |
| r5 = ∞ | d5 = 0.03 | | |
| r6 = ∞ | d6 = 4.64 | N6 = 1.66 | ν6 = 50.88 |
| r7 = ∞ | d7 = 0.97 | | |
| r8 = −1,779.62 | d8 = 1.30 | N8 = 1.85 | ν8 = 23.78 |
| r9 = 39.84 | d9 = Variable | | |
| r10 = Rotationally | d10 = 5.39 | N10 = 1.69 | ν10 = 53.20 |
| symmetric | | | |
| aspherical | | | |
| surface | | | |
| r11 = −69.26 | d11 = Variable | | |
| r12 = 23.36 | d12 = 3.73 | N12 = 1.80 | ν12 = 46.58 |
| r13 = 15.04 | d13 = 21.00 | | |

(Aspherical coefficient)

| | R | k | c2 | c4 | c6 | c8 |
|---|---|---|---|---|---|---|
| r10 | 20.03 | −1.22 | 0.00 | −5.58E−07 | −3.33E−09 | −4.53E−12 |

(Variable distance)

| | | | |
|---|---|---|---|
| Diopter | −1.00 | −3.00 | +1.00 |
| d9 | 2.49 | 0.80 | 4.41 |
| d11 | 2.42 | 4.11 | 0.50 |

(Display optical system entire data)

| Image display surface | |
|---|---|
| diagonal length L1 | ω |
| 13.22 | 27.96° |

(Lens data)

| Paraxial radius | Axial surface | Refractive | Abbe number |
|---|---|---|---|
| of curvature | distance | index (Nd) | (νd) |
| r1 = ∞ | d1 = 1.20 | N1 = 1.52 | ν1 = 64.14 |
| r2 = ∞ | d2 = 0.22 | N2 = 1.52 | ν2 = 58.60 |
| r3 = ∞ | d3 = 2.51 | | |
| r4 = Rotationally | d4 = 6.80 | N4 = 1.57 | ν4 = 34.00 |
| symmetric | | | |
| aspherical | | | |
| surface | | | |
| r5 = ∞ | d5 = 10.69 | N5 = 1.57 | ν5 = 34.00 |
| r6 = Rotationally | d6 = 6.87 | N6 = 1.57 | ν6 = 34.00 |
| asymmetric | | | |
| aspherical | | | |
| surface | | | |
| r7 = ∞ | d7 = 0.40 | | |
| r8 = ∞ | d8 = 3.10 | N8 = 1.85 | ν8 = 40.39 |
| r9 = Rotationally | d9 = 0.40 | | |
| symmetric | | | |
| aspherical | | | |
| surface | | | |
| r10 = ∞ | d10 = 21.31 | N10 = 1.66 | ν10 = 50.88 |
| r11 = ∞ | d11 = 0.03 | | |
| r12 = ∞ | d12 = 4.64 | N12 = 1.66 | ν12 = 50.88 |
| r13 = ∞ | d13 = 0.97 | | |
| r14 = −1779.62 | d14 = 1.30 | N14 = 1.85 | ν14 = 23.78 |
| r15 = 39.84 | d15 = Variable | | |
| r16 = Rotationally | d16 = 5.39 | N16 = 1.69 | ν16 = 53.20 |
| symmetric | | | |
| aspherical | | | |
| surface | | | |
| r17 = −69.26 | d17 = Variable | | |
| r18 = 23.36 | d18 = 3.73 | N18 = 1.80 | ν18 = 46.58 |
| r19 = 15.04 | d19 = 21.00 | | |

(Aspherical coefficient)

| | R | k | c2 | c4 | c6 | c8 | c10 |
|---|---|---|---|---|---|---|---|
| r4 | −274.66 | −1.07E+01 | 0.00 | −1.08E−04 | −1.07E−06 | 0.00 | 0.00 |
| r9 | −27.62 | 6.78 | 0.00 | −3.45E−05 | 1.04E−07 | −2.13E−10 | 1.37E−13 |
| r16 | 20.03 | −1.22 | 0.00 | −5.58E−07 | −3.33E−09 | −4.53E−12 | 0.00 |

| | c20 | c02 |
|---|---|---|
| r6 | −2.17E−04 | −2.68E−04 |
| | c30 | c12 |
| r6 | −4.32E−06 | −1.03E−05 |

| | c40 | c22 | c04 |
|---|---|---|---|
| r6 | 3.09E−06 | 5.84E−06 | 5.02E−06 |
| | c50 | c32 | c14 |
| r6 | 1.13E−07 | 1.93E−07 | 1.12E−07 |

| | c60 | c42 | c24 | c06 |
|---|---|---|---|---|
| r6 | 1.32E−08 | 1.66E−08 | 2.57E−08 | −1.80E−09 |
| | c70 | c52 | c34 | c16 |
| r6 | 5.28E−10 | 3.82E−09 | −1.01E−10 | 4.27E−09 |

| | c80 | c62 | c44 | c26 | c08 |
|---|---|---|---|---|---|
| r6 | −9.47E−11 | −1.08E−10 | −6.49E−10 | −2.14E−11 | 4.87E−11 |
| | c90 | c72 | c54 | c36 | c18 |
| r6 | −1.12E−11 | −4.79E−11 | 5.06E−11 | 8.43E−11 | −4.05E−11 |

| | c100 | c82 | c64 | c46 | c28 | c010 |
|---|---|---|---|---|---|---|
| r6 | −1.57E−12 | −8.58E−13 | 1.91E−12 | 1.10E−11 | −3.15E−12 | −3.15E−13 |

(Variable distance)

| | | | |
|---|---|---|---|
| Diopter | −1.00 | −3.00 | +1.00 |
| d15 | 2.49 | 0.80 | 4.41 |
| d17 | 2.42 | 4.11 | 0.50 |

(Conditional Expression)

| Conditional Expression | Value |
|---|---|
| f1/f | 0.43 |
| (f1/f) × (L/L1) | 1.36 |
| 6 | 50° |

### MODIFIED EXAMPLES

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-158591, filed Aug. 4, 2014, which is hereby incorporated by reference herein in its entirety.

What is claimed is:

1. A finder system, comprising:
an observation optical system configured to convert a subject image formed on a predetermined surface into an erect image via an erect image forming member, and cause the erect image to be transmitted through a first optical surface that is inclined with respect to an optical axis, thereby observing the erect image via an eyepiece lens; and
a display optical system configured to cause an image indicating display information of a display member to be reflected on the first optical surface, thereby observing the image via the eyepiece lens in the same field of view as the subject image,
the display optical system comprising, between the display member and the eyepiece lens:
an optical member including at least two reflection surfaces; and
a lens unit having a positive refractive power,
the optical member and the lens unit being arranged along an optical path from the display member side to the eyepiece lens side in the stated order.

2. A finder system according to claim 1, further comprising a second optical surface that is arranged in an optical path between the optical member and the first optical surface and is inclined with respect to the optical axis,
wherein the observation optical system is an optical system configured to observe a subject image transmitted through the first optical surface and the second optical surface, and
wherein the display optical system is an optical system configured to observe an image indicating the display information reflected on the second optical surface and the first optical surface.

3. A finder system according to claim 1, wherein at least one of the reflection surfaces of the optical member is a total reflection surface.

4. A finder system according to claim 2, wherein the second optical surface of the optical member is a total reflection surface.

5. A finder system according to claim 2, wherein the lens unit is arranged in an optical path between the optical member and the second optical surface.

6. A finder system according to claim 1, wherein the following conditional expression is satisfied:
0.3<f₁/f<1.0,
where f₁ represents a focal length of the lens unit, and f represents a focal length of the eyepiece lens at −1 diopter.

7. A finder system according to claim 6, wherein the following conditional expression is satisfied:
1.2<(f₁/f)×(L/L₁)<1.5,
where L₁ represents a diagonal length of the display member, and L represents a diagonal length of the display member on an observation surface.

8. A finder system according to claim 6, wherein the following conditional expression is satisfied:
40°<θ<75°,
where θ represents an angle formed by a normal to the display member and a central axis of the lens unit.

9. A finder system according to claim 1, wherein at least one reflection surface of the optical member is a rotationally asymmetric aspherical surface.

10. A finder system according to claim 1, wherein a surface including an optical path of a light beam passing on an optical axis of the observation optical system and a surface including an optical path of a light beam passing on an optical axis of the lens unit and reflected on the first optical surface are different from each other.

11. An optical apparatus, comprising:
an objective optical system configured to form a subject image on a predetermined surface;
an observation optical system configured to convert the subject image into an erect image via an erect image forming member, and cause the erect image to be transmitted through a first optical surface that is inclined with respect to an optical axis, thereby observing the erect image via an eyepiece lens; and
a display optical system configured to cause an image indicating display information of a display member to be reflected on the first optical surface, thereby observing the image via the eyepiece lens in the same field of view as the subject image,
the display optical system comprising, between the display member and the eyepiece lens:
an optical member including at least two reflection surfaces; and
a lens unit having a positive refractive power,
the optical member and the lens unit being arranged along an optical path from the display member side to the eyepiece lens side in the stated order.

12. An optical apparatus according to claim 11, further comprising:
a reflective mirror configured to reflect light transmitted through the objective optical system;
an image pickup element configured to receive light of the subject image; and
a display member,
wherein, when the reflective mirror is located on an optical axis of the objective optical system, the display member displays information on a photographing state, and when the reflective mirror is not located on the optical axis of the objective optical system, the display member displays image information from the image pickup element.
